(19) United States
(12) Patent Application Publication
(10) Pub. No.: US 2024/0090702 A1
(43) Pub. Date: Mar. 21, 2024

(54) COOKING APPARATUS WITH AUTOMATIC DOORS

(71) Applicant: Elaine Chavez, LaVernia, TX (US)

(72) Inventor: Thomas Rishton, La Vernia, TX (US)

(21) Appl. No.: 18/371,364

(22) Filed: Sep. 21, 2023

Related U.S. Application Data
(60) Provisional application No. 63/408,793, filed on Sep. 21, 2022.

(51) Int. Cl. A47J 37/07

(52) U.S. Cl. CPC A47J 37/0786

(57) ABSTRACT

An apparatus for cooking food and having automatic doors includes two doors coupled to a motor through a plurality of connectors. The connectors may include a series of cables, pulleys, articulating arms, and the like. The apparatus is configured so that the doors open and close in response to input from a user. The user input may include pressing a button, using an app on a mobile device, motion sensing, or the like. The apparatus may be a barbecue grill, a smoker, a vertical rotisserie cooker, or the like. In the barbecue grill, the grates of the grill are supported from the base of the grill so that the grates do not interfere with the opening and closing of the doors. The doors may open and close in the horizontal direction or vertical direction.

### CROSS-REFERENCE TO RELATED APPLICATIONS

This application claims priority to U.S. Provisional Patent Application Ser. No. 63/408,793, filed Sep. 21, 2022, entitled “Barbecue Grill with Automatic Doors,” the entire contents of which are incorporated herein by reference.

### BACKGROUND

### Field of the Art

The present invention relates to an apparatus for cooking food, the apparatus having doors that open and close automatically, thus avoiding the possibility of burning the user. In particular, the present invention relates to a cooking apparatus having two doors that are connected to a motor through a plurality of connectors. The motor is activated in response to input from a user, thereby causing the doors to open or close.

### Discussion of the State of the Art

Outdoor grilling and barbecuing are very popular methods for cooking food. Many residences and outdoor spaces in the US have a barbecue grill. One disadvantage of a barbecue grill is that opening the lid while food is cooking may be hazardous to the user. Currently available barbecue grills include a handle on the lid and the user grasps the handle to raise the lid relative to the grill grates and the flame or heat source. Due to the close proximity between the user and the hot barbecue grill, singed hair is a common occurrence when opening a hot barbecue. Flare ups causing burns may also occur.

As such, there is a need for a barbecue grill that avoids these disadvantages. Having the ability to remotely open a hot barbecue grill from a safe distance would make grilling a much more enjoyable experience.

### SUMMARY

The present invention relates to an apparatus for cooking food that has doors that open automatically. The apparatus may be a barbecue grill, a vertical rotisserie cooker, a smoker, or the like. The doors may open in response to input from a user, such as pressing a button, motion detection, input through an app on a mobile device, pressing a button on a keychain or wireless remote, or the like. The automatic doors are connected to a motor through a plurality of connectors, such as cables, pulleys, articulating arms, or the like. The input from the user causes the motor to activate, which causes the doors to open or close, depending on the input from the user and/or the current configuration (i.e., open configuration or closed configuration) of the doors.

In one example, the present invention is an apparatus for cooking food, the apparatus having automatic doors. The apparatus includes a main body having a cooking area therein. The cooking area includes a heat source adjacent to a food holding area. The apparatus further includes a first door, a second door, and a motor configured for moving the first door and the second door between an open configuration and a closed configuration upon receiving user input through an input device. The cooking area is accessible to a user when the first door and the second door are in the open configuration. The apparatus further includes a plurality of connectors for coupling the first door and the second door to the motor.

The plurality of connectors may include at least two pulleys and a series of cables that are operatively engaged with the pulleys and with the motor. The plurality of connectors may further include at least two arms that are rotatably coupled to the first door and/or the second door. The plurality of connectors may further include two first door arms that are rotatably coupled to the first door and two second door arms that are rotatably coupled to the second door. In another example, the plurality of connectors may further include two first door arms that are fixedly coupled to the first door, two second door arms that are rotatably coupled to the second door, and an elevator arm that is rotatably coupled to the first door arm and the second door arm.

The apparatus may further include two tracks, wherein one track is positioned on each side of the apparatus. Still further, the apparatus may include two blocks, each one of the blocks operatively engaged with a respective one of the tracks and configured to ride on the respective one of the tracks. Each one of the blocks may be fixedly coupled to a respective one of the cables in the series of cables.

The apparatus may be a barbecue grill, and the first door and the second door may be in a horizontal configuration. The apparatus may be a vertical rotisserie cooker and the first door and the second door may be in a vertical configuration.

The apparatus may further include a cook box, a burner assembly, and a gap between the cook box and the burner assembly. The gap may be sized and shaped to allow the first door to travel through the gap during an opening or closing process.

The first door may be positioned inside of the grill body when the first door and the second door are in the open configuration. Both the first door and the second door may be positioned inside of the grill body when the first door and the second door are in the open configuration. Alternatively, the second door may hinge upward relative to the main body when the first door and the second door are in the open configuration. The first door and the second door may be the same size and shape as each other.

### BRIEF DESCRIPTION OF THE DRAWING FIGURES

The accompanying drawings illustrate exemplary embodiments and, together with the description, serve to explain the principles of the invention according to the embodiments. It will be appreciated by one skilled in the art that the particular arrangement illustrated in the drawing is merely exemplary and is not to be considered as limiting the scope of the invention in any way.

FIGS. 1A and 1B are perspective views of a barbecue grill having automatic doors in a closed configuration and an open configuration, respectively, in accordance with an embodiment of the present invention.

FIGS. 1C and 1D are perspective views of the barbecue grill of FIGS. 1A and 1B in a closed configuration and an open configuration, respectively, and having some portions removed to show the opening and closing mechanism, in accordance with an embodiment of the present invention.

FIG. 1E is a perspective view of the burner assembly of the barbecue grill of FIGS. 1A and 1B with other parts of the grill shown in phantom, in accordance with an embodiment of the present invention.

FIG. 1F is a perspective view of the cook box of the barbecue grill of FIGS. 1A and 1B with other parts of the grill shown in phantom, in accordance with an embodiment of the present invention.

FIGS. 2A and 2B are perspective views of a barbecue grill having automatic doors in a closed configuration and an open configuration, respectively, in accordance with an embodiment of the present invention.

FIG. 2C is a perspective view of the barbecue grill of FIGS. 2A and 2B in an open configuration and having some portions removed to show the opening and closing mechanism, in accordance with an embodiment of the present invention.

FIG. 2D is a close up view of the cable and pulley system of the opening and closing mechanism of the barbecue grill of FIGS. 2A and 2B, in accordance with an embodiment of the present invention.

FIGS. 3A and 3B are perspective views of a barbecue grill having automatic doors in a closed configuration and an open configuration, respectively, in accordance with an embodiment of the present invention.

FIGS. 3C and 3D are perspective views of the barbecue grill of FIGS. 3A and 3B in a closed configuration and an open configuration, respectively, and having some portions removed to show the opening and closing mechanism, in accordance with an embodiment of the present invention.

FIGS. 4A and 4B are perspective views of a barbecue grill having automatic doors in a closed configuration and an open configuration, respectively, in accordance with an embodiment of the present invention.

FIGS. 4C and 4D are perspective views of the barbecue grill of FIGS. 4A and 4B in a closed configuration and an open configuration, respectively, and having some portions removed to show the opening and closing mechanism, in accordance with an embodiment of the present invention.

FIG. 4E is a plan view of the cable and pulley system of the opening and closing mechanism of the barbecue grill of FIGS. 4A and 4B, in accordance with an embodiment of the present invention.

FIGS. 4F and 4G illustrate two of the cables in the cable and pulley system of the opening and closing mechanism of the barbecue grill of FIGS. 4A and 4B, in accordance with an embodiment of the present invention.

FIG. 5 is a perspective view of a vertical rotisserie cooker having automatic doors in a closed configuration, in accordance with an embodiment of the present invention.

FIGS. 6A and 6B are perspective views of a barbecue grill having automatic doors in a closed configuration and an open configuration, respectively, in accordance with an embodiment of the present invention.

FIGS. 6C and 6D are perspective views of the barbecue grill of FIGS. 6A and 6B in a closed configuration and an open configuration, respectively, and having some portions removed to show the opening and closing mechanism, in accordance with an embodiment of the present invention.

### DETAILED DESCRIPTION

The apparatus disclosed herein is an apparatus for cooking food that has doors that open and close automatically. The cooking apparatus preferably includes two doors that are configured to move towards each other and away from each other. The cooking apparatus further includes a motor and each one of the doors is coupled to the motor through a plurality of connectors, such as cables, pulleys, articulating arms, or the like. The doors of the cooking apparatus may open in a horizontal direction or a vertical direction. As such, the cooking apparatus may be a barbecue grill, a vertical rotisserie cooker, a smoker, or the like. For the barbecue grill, the grill grates are suspended and coupled to the main body of the barbecue grill in a manner that does not interfere with the opening and closing of the doors.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application do not, in and of itself, indicate a requirement that the steps be performed in that order. The steps of described processes may be performed in any order practical. Further, some steps may be performed simultaneously despite being described or implied as occurring non-simultaneously (i.e., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially, concurrently or in reverse order, depending on the functionality involved, as would be understood by those having ordinary skill in the art.

### Overview

The apparatus of the present invention is a cooker or a barbecue grill having automatic doors that are configured to open and close in response to input from a user. For example, the doors may be configured to open and close in response to the press of a button, motion sensing, communication from an app on a mobile device, press of a button on a key fob or wireless remote, or the like. For the barbecue grill, the grates of the grill are supported from the base of the main body of the barbecue grill rather than being coupled to the upper periphery of the main body so that the grates do not interfere with the opening and closing of the doors.

### Apparatus

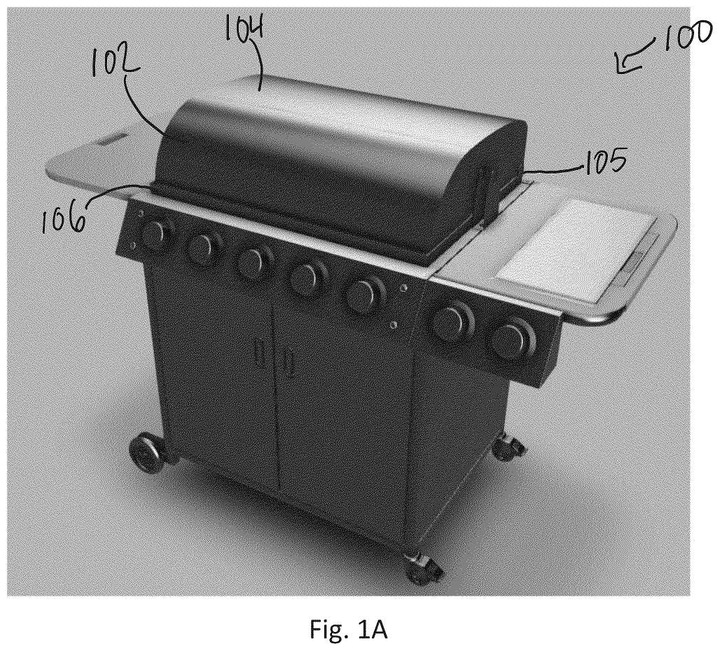

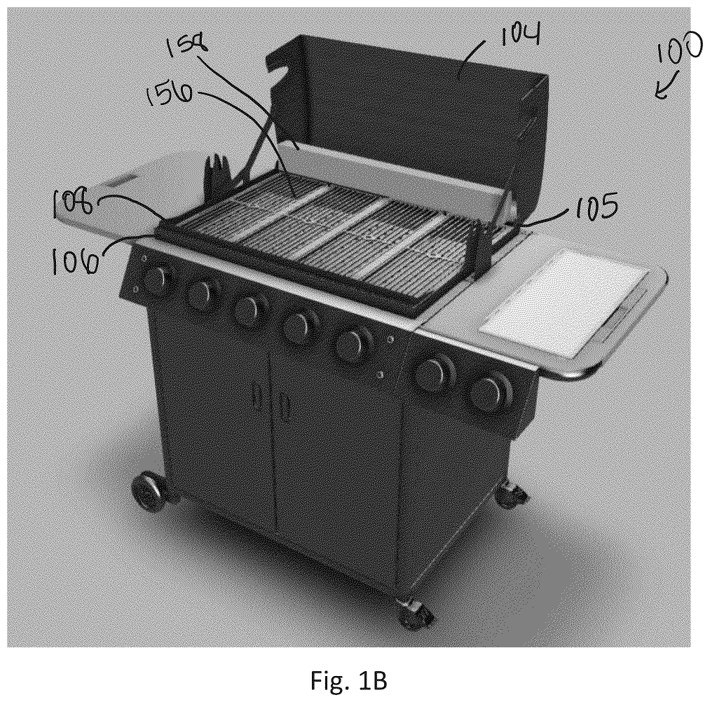

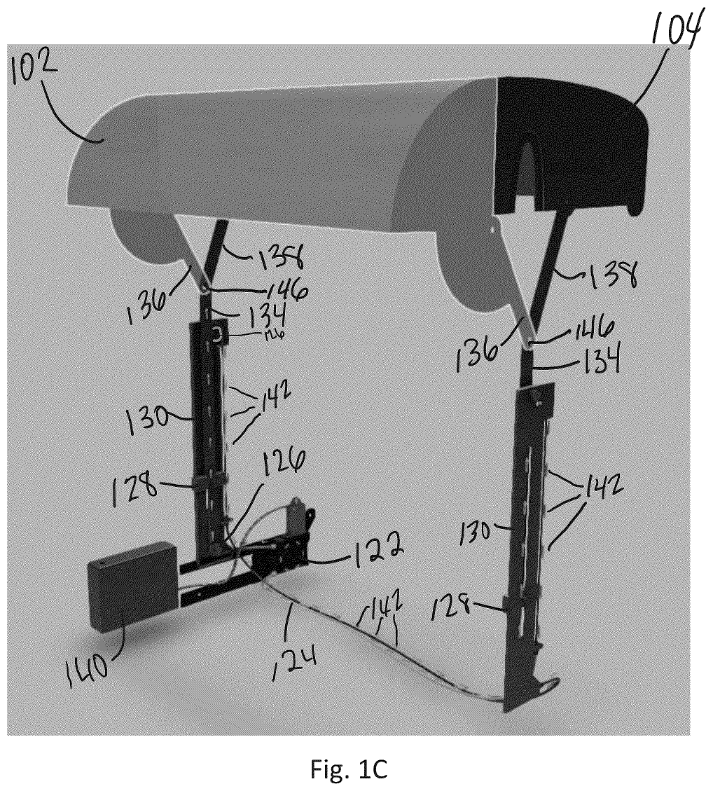

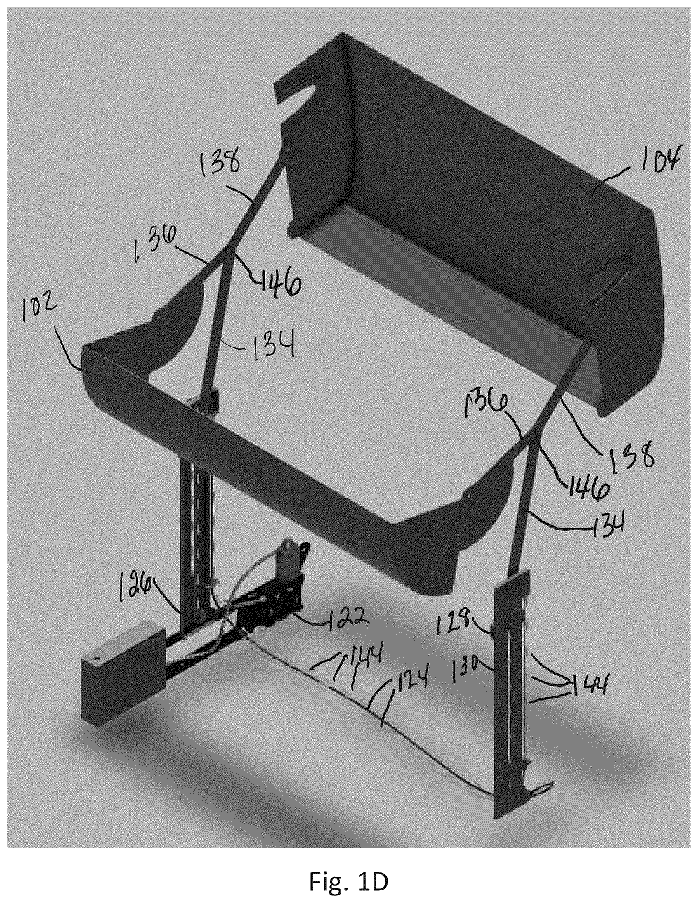

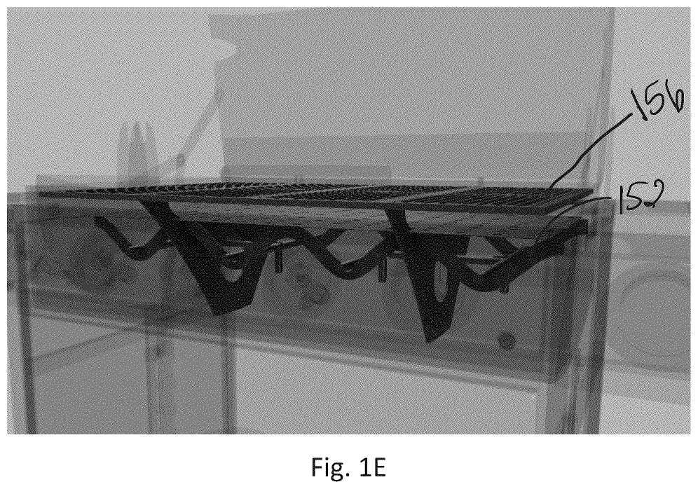

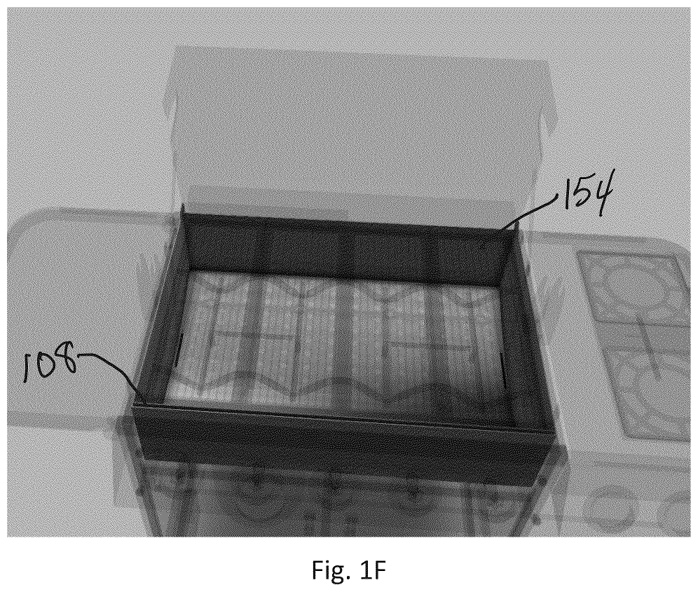

In one example, shown in FIGS. 1A-1D, the apparatus for cooking food is a barbecue grill 100 that includes a first door 102 and a second door 104 that open and close automatically. The doors 102, 104 are attached to a main body 106 of the grill. The main body 106 has a cooking area that includes grates 156 for holding food during cooking. The cooking area further includes a burner assembly 152 (see FIG. 1E) below the grates 156, and may also include an infrared burner 158. The cooking area is accessible to a user when the grill 100 is in the open configuration.

The first door 102, also referred to as the front door 102, opens by rotating downward relative to the main body 106 of the grill 100. At the same time the front door 102 is rotating downward, the second door 104, also referred to as the rear door 104, hinges upward relative to the main body 106 of the grill. The rear door 104 is hingedly coupled to the main body 106 at the rear edge of the grill 100 and rotates about the pivot point 105. FIG. 1A depicts the barbecue grill 100 with the doors 102, 104 in a closed position and FIG. 1B depicts the barbecue grill 100 with the doors 102, 104 in an open position. As shown in FIG. 1B, when the barbecue grill 100 is in the open position, the front door 102 is rotated to a position inside of the main body 106 of the grill 100. As such, there is gap 108 between the main body 106 and the periphery of the upper portion of the burner assembly 152 that is sized and shaped to accommodate the front door 102 when the front door 102 rotates into the open position.

One advantage of the grill 100 having two doors 102, 104 is that the heat from the grill 100 radiates upward when the grill doors 102, 104 are opened. Thus, heat from the grill 100 radiating toward the user is avoided. Conversely, a conventional grill has a single door and when the door is manually opened, heat from the grill radiates towards the user, potentially causing pain and discomfort to the user.

The doors 102, 104 of the grill 100 open and close in response to input from a user. The input may be a press of a button. The button may be on the grill 100 or may be on a wireless remote control or key fob. In another example, the user input may be through an app on a mobile device. In yet another example, the user input may be through a motion sensor.

The opening and closing mechanism of the barbecue grill 100 includes an elevating mechanism that moves up and down towards and away from the doors 102, 104. The opening and closing mechanism will be discussed in further detail with reference to FIGS. 1C and 1D. The doors 102, 104 of the grill 100 are coupled to a motor 122 through a series of cables, pulleys, and/or arms. The motor 122 is activated through input from the user to cause the doors 102, 104 to open or close. Notably, a single motor 122 is used to open and close the doors 102, 104. In this manner, the doors 102, 104 move simultaneously during the opening and closing processes. The mechanism for opening and closing the doors 102, 104 is a closed loop system that includes the motor 122, cables 124, pulleys 126, and arms 134, 136, 138. However, it will be readily understood that the grill 100 is not limited to one motor and that two or more motors may be used to open and close the doors 102, 104. The single motor 122 causes the doors 102, 104 to open and close simultaneously.

When the doors 102, 104 reach the open configuration, the motor 122 automatically switches off. For example, when the doors 102, 104 reach a threshold open configuration, a different voltage reading is sent to the relay, which causes the motor 122 to switch off. Similarly, when the doors 102, 104 move from the open configuration to the closed configuration, the doors 102, 104 engage a stop, which causes the motor 122 to switch off. Since the opening and closing mechanism is a closed loop system, the doors 102, 104 move at the same speed at the same time and arrive in the same open or closed position every time the mechanism is operated.

The opening and closing mechanism depicted in FIGS. 1C and 1D includes a series of cables 124, a plurality of pulleys 126, blocks 128 that ride on tracks 130, elevator arms 134, front door arms 136, and rear door arms 138. The motor 122 is coupled to a power source 140. The motor 122 is also operatively coupled to the cables 124. Input from the user causes the motor 122 to activate in a first or second direction. If the doors 102, 104 are closed, the user input causes the motor 122 to activate in a first direction to open the doors 102, 104. If the doors 102, 104 are open, the user input causes the motor 122 to activate in a second direction opposite of the first direction in order to close the doors 102, 104. Activation of the motor 122 in the first direction causes the cables 124 to move in a first direction, as indicated by the arrows 142 shown in FIG. 1C. Conversely, activation of the motor 122 in the second direction causes the cables 124 to move in a second direction, as indicated by the arrows 144 shown in FIG. 1D. The cables 124 are wrapped around the pulleys 126 and movement of the cables 124 causes the pulleys 126 to rotate in conjunction with the movement of the cables 124. The pulleys 126 are fixed pulleys. That is, the pulleys 126 rotate about a fixed rotation axis.

Each side of the grill 100 includes a track 130 having a block 128 operatively engaged therewith. The blocks 128 are fixedly coupled to the cables 124 so that movement of the cables 124 in a first direction causes the blocks to lift upwards towards the doors 102, 104, and movement of the cables 124 in a second direction causes the blocks 128 to move downward away from the doors 102, 104. The blocks 128 ride on tracks 130. The tracks 130 hold the blocks 128 in position along their intended pathway. The elevator arms 134 are rotatably coupled to the blocks 128 so that, as the blocks 128 move upwards, the elevator arms 134 move upwards and hinge slightly to the rear, as shown in FIG. 1D. The elevator arms 134 are rotatably coupled to the front door arms 136 and the rear door arms 138. As the elevator arms 134 move upwards, the front door arms 136 rotate forward from the position shown in FIG. 1C to the position shown in FIG. 1D. As the elevator arms 134 move upwards, the rear door arms 138 rotate towards the rear of the grill 100 from the position shown in FIG. 1C to the position shown in FIG. 1D. The front door arms 136 may be fixedly coupled to the front door 102. The front door arms 136 and the front door 102 may be a unitary piece. The rear door arms 138 may be rotatably coupled to the rear door 104 and to the elevator arm 134. In this manner, the rear door 104 may rotate relative to the rear door arms 138. The front door arms 136 and the rear door arms 138 rotate about a pivot point 146 at the top end of the elevator arms 134. As the blocks 128 move downwards, the elevator arms 134 move downwards and rotate back to a substantially vertical position, and the front door arm 136 and rear door arm 138 rotate from the position shown in FIG. 1D to the position shown in FIG. 1C.

The grates 156 and the burner assembly 152 (shown in FIG. 1E) are supported by the base of the cookbox 154 (shown in FIG. 1F) so that the grates 156 and the burner assembly 152 do not interfere with the opening and closing of the front door 102.

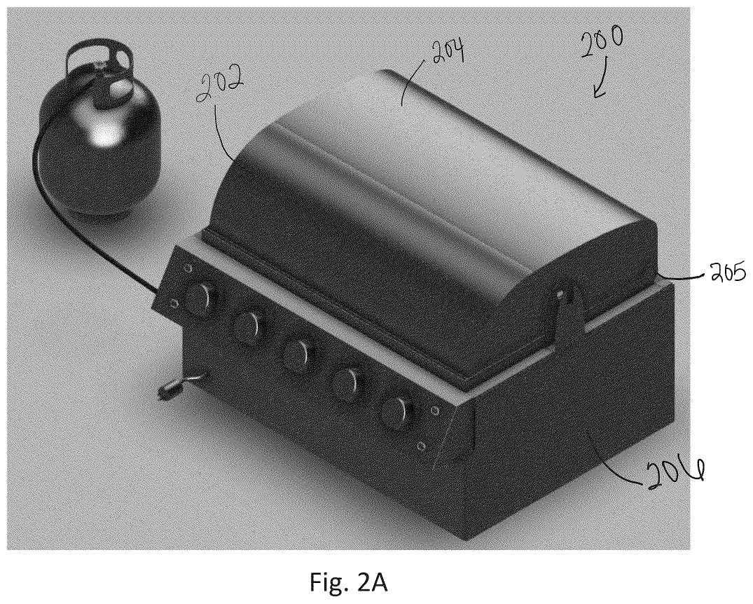

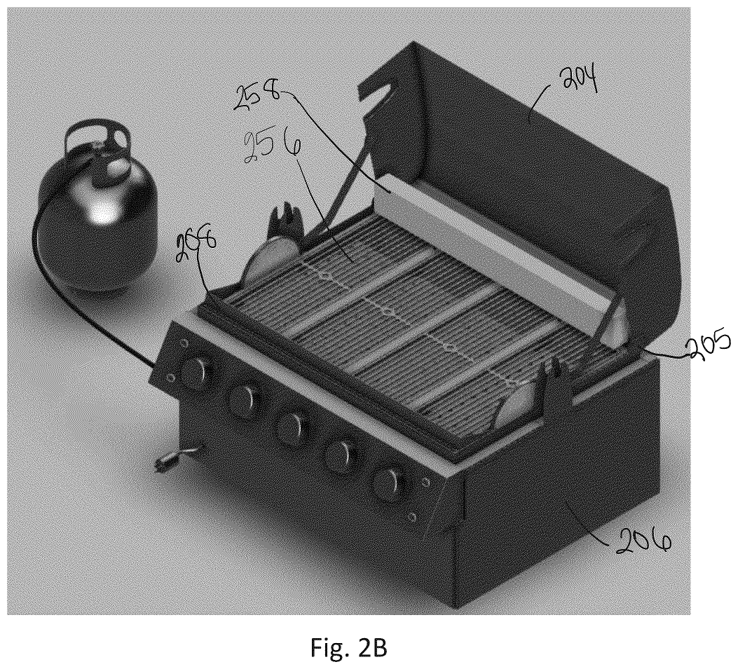

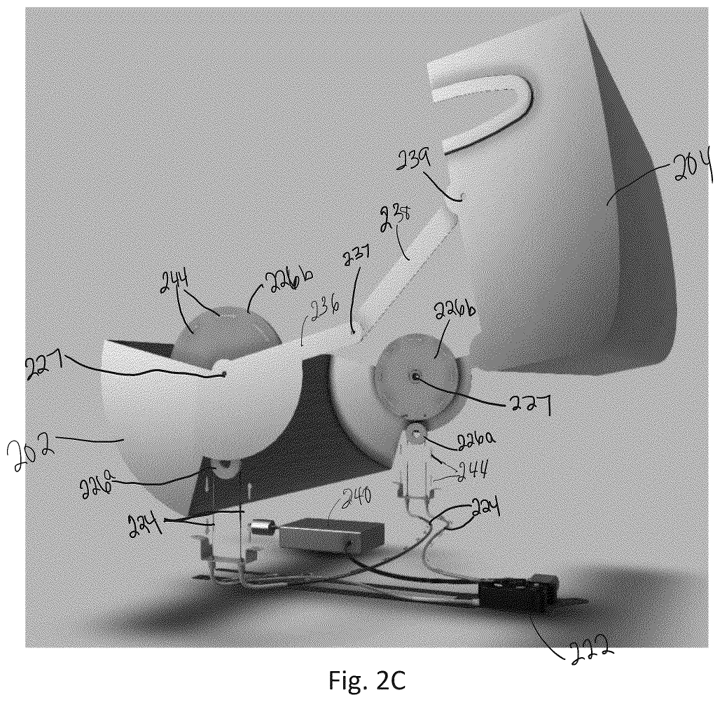

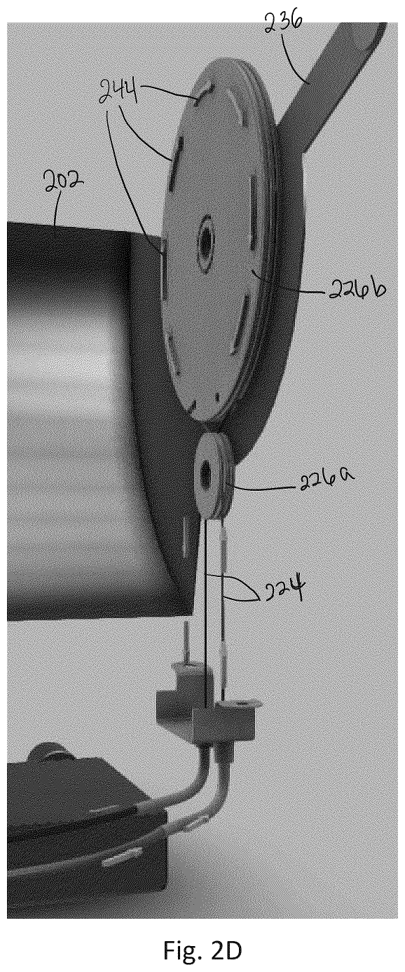

In another example, shown in FIGS. 2A-2D, the apparatus for cooking food is a barbecue grill 200 that includes doors 202 and 204 that open and close automatically. The grill 200 is similar to the grill 100 discussed above, but the grill 200 is smaller and more compact, and the opening and closing mechanism is different to accommodate the smaller size. The smaller size of the grill 200 is advantageous for tailgating, using on a boat or RV, installing on a built-in patio barbecue cabinet, or the like.

The doors 202, 204 are attached to a main body 206 of the grill 200. The main body 206 has a cooking area that includes grates 256 for holding food during cooking. The cooking area further includes a burner assembly (similar to the burner assembly 152 shown in FIG. 1E) below the grates 256, and may also include an infrared burner 258. The cooking area is accessible to a user when the grill 200 is in the open configuration.

The first door 202, also referred to as the front door 202, opens by rotating downward relative to the main body 206 of the grill 200. At the same time the front door 202 is rotating downward, the second door 204, also referred to as the rear door 204, hinges upward relative to the main body 206 of the grill. The rear door 204 is hingedly coupled to the main body 206 of the grill 200 at the rear edge of the grill 200 and rotates about the pivot point 205. FIG. 2A depicts the barbecue grill 200 with the doors 202, 204 in a closed position and FIG. 2B depicts the barbecue grill 200 with the doors 202, 204 in an open position. As shown in FIG. 2B, when the barbecue grill 200 is in the open position, the front door 202 is rotated to a position inside of the main body 206. As such, there is gap 208 between the main body 206 and the periphery of the upper portion of the burner assembly that is sized and shaped to accommodate the front door 202 when the front door 202 rotates into the open position.

One advantage of the grill 200 having two doors 202, 204 is that the heat from the grill 200 radiates upward when the grill doors 202, 204 are opened. Heat from the grill 200 radiating toward the user is avoided. Conversely, a conventional grill has a single door and when the door is manually opened, heat from the grill radiates towards the user, potentially causing pain and discomfort to the user.

The doors 202, 204 of the grill 200 open and close in response to input from a user. The input may be a press of a button. The button may be on the grill 200 or may be on a wireless remote control or key fob. In another example, the user input may be through an app on a mobile device. In yet another example, the user input may be through a motion sensor.

The opening and closing mechanism of the barbecue grill 200 includes only pulleys, cables, and articulating arms, and does not include the elevating mechanism of the previous embodiment in the interest of making the grill 200 more compact. The opening and closing mechanism of the barbecue grill 200 will be discussed in further detail with reference to FIGS. 2C and 2D. The doors 202, 204 of the grill 200 are coupled to a motor 222 through a series of cables, pulleys, and arms. The motor 222 is activated through input from the user to cause the doors 202, 204 to open or close. Notably, a single motor 222 is used to open and close the doors 202, 204. In this manner, the doors 202, 204 move simultaneously during the opening and closing processes. The mechanism for opening and closing the doors 202, 204 is a closed loop system that includes the motor 222, cables 224, pulleys 226, and arms 236, 238. However, it will be readily understood that the grill 200 is not limited to one motor and that two or more motors may be used to open and close the doors 202, 204. The single motor 222 causes the doors 202, 204 to open and close simultaneously.

When the doors 202, 204 reach the open configuration, the motor 222 automatically switches off. For example, when the doors 202, 204 reach a threshold open configuration, a different voltage reading is sent to the relay, which causes the motor 222 to switch off. Similarly, when the doors 202, 204 move from the open configuration to the closed configuration, the doors 202, 204 engage a stop, which causes the motor 222 to switch off. Since the opening and closing mechanism is a closed loop system, the doors 202, 204 move at the same speed at the same time and arrive in the same open or closed position every time the mechanism is operated.

The opening and closing mechanism depicted in FIGS. 2C and 2D includes a series of cables 224, a plurality of pulleys 226, and arms 236, 238. The motor 222 is coupled to a power source 240. The motor 222 is also operatively coupled to the cables 224. Input from the user causes the motor 222 to activate in a first or second direction. If the doors 202, 204 are closed, the user input causes the motor 222 to activate in a first direction to open the doors 202, 204. If the doors 202, 204 are open, the user input causes the motor 222 to activate in a second direction opposite of the first direction in order to close the doors 202, 204. Activation of the motor 222 in the first direction causes the cables 224 to move in a first direction (not shown). Conversely, activation of the motor 222 in the second direction causes the cables 224 to move in a second direction, as indicated by the arrows 244 shown in FIG. 2C. The cables 224 wind around the pulleys 226 and movement of the cables 224 causes the pulleys 226 to rotate in conjunction with the movement of the cables 224. The cables 224 wind around the small pulley 226a and the large pulley 226b. The pulleys 226 are fixed pulleys. That is, the wheels of the pulleys 226 rotate around a fixed rotation axis 227.

The front door 202 is fixedly coupled to the large pulleys 226b so that when the large pulleys 226b rotate, the front door 202 also rotates. The front door 202 is fixedly coupled to a front door arm 236 so that when the large pulley 226b and the front door 202 rotate, the front door arm 236 also rotates. The large pulleys 226b, the front door 202, and the front door arms 236 rotate around a fixed rotation axis 227. At the opposite end of the front door arms 236, rear door arms 238 are rotatably coupled to the front door arms 236. The front door arms 236 and the rear door arms 238 are coupled together at, and configured to rotate about, a rotation axis 237. The rear door arms 238 are also rotatably coupled to the rear door 204 at a connection point 239. As the large pulley 226b rotates, the front door 202 rotates therewith, the front door arms 236 rotate upwards or downwards, and the rear door arms 238 rotate upwards or downwards.

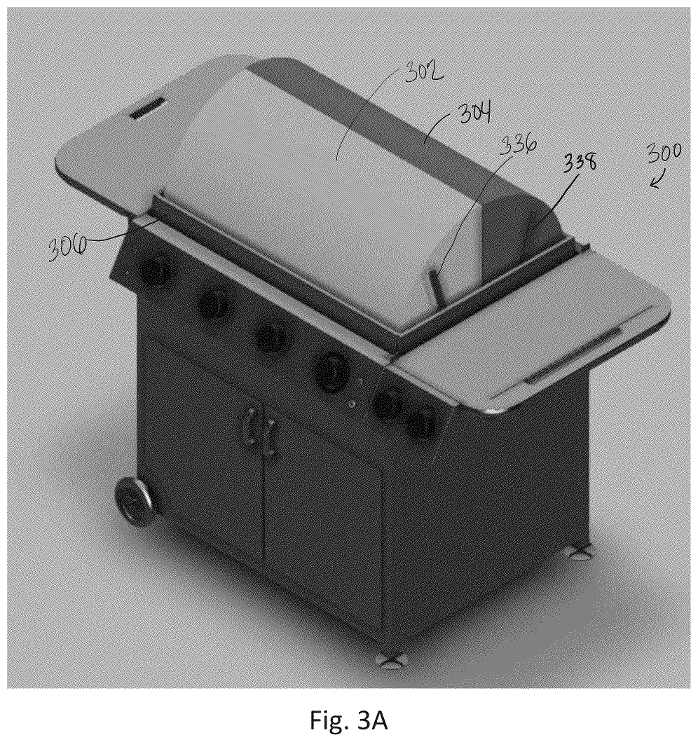

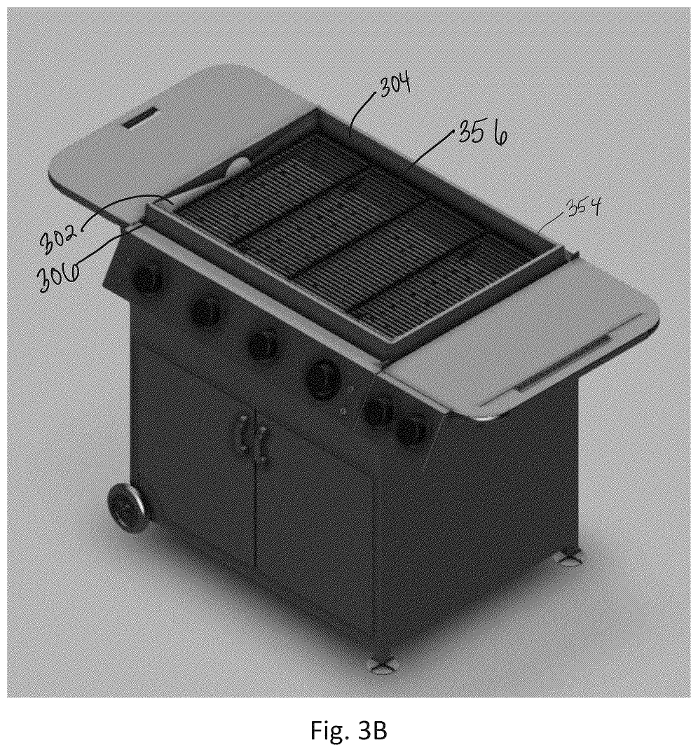

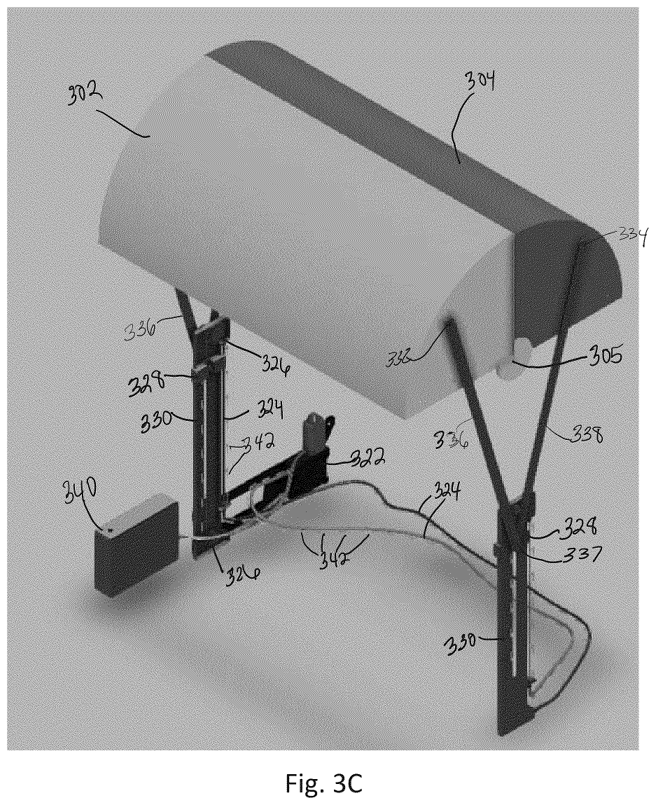

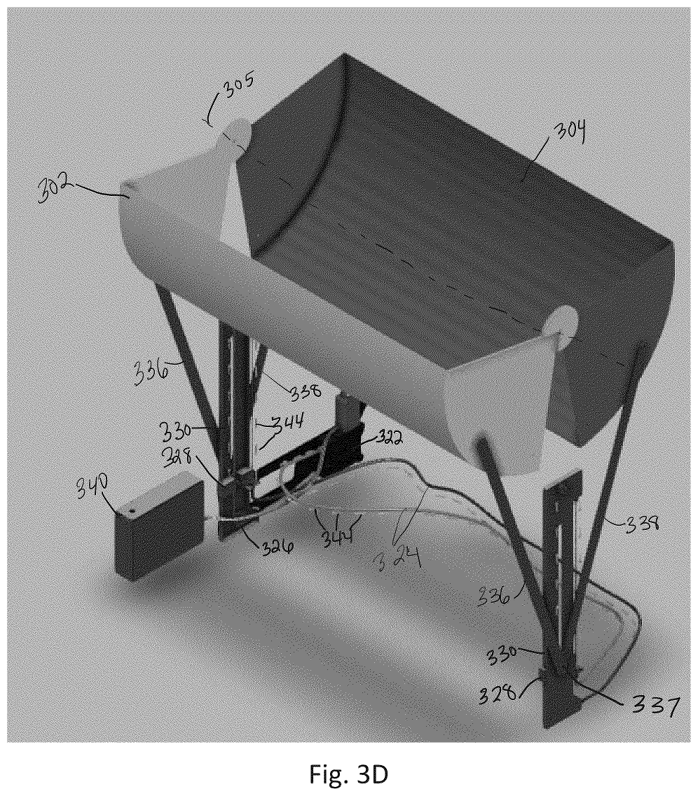

In another example, shown in FIGS. 3A-3D, the apparatus for cooking food is a barbecue grill 300 that includes doors 302 and 304 that open and close automatically. The doors 302, 304 are attached to a main body 306 of the grill 300. The main body 306 has a cooking area that includes grates 356 for holding food during cooking. The cooking area further includes a burner assembly (similar to the burner assembly 152 shown in FIG. 1E) below the grates 356. The cooking area is accessible to a user when the grill 300 is in the open configuration.

The first door 302, also referred to as the front door 302, opens by rotating downward relative to the main body 306 of the grill 300. Similarly, the second door 304, also referred to as the rear door 304, rotates downward relative to the main body 306 of the grill. The doors 302, 304 are the same size and shape as each other. The doors 302, 304 rotate about a fixed rotation axis 305. FIG. 3A depicts the barbecue grill 300 with the doors 302, 304 in a closed position and FIG. 3B depicts the barbecue grill 300 with the doors 302, 304 in an open position. As shown in FIG. 3B, when the barbecue grill 300 is in the open position, both doors 302, 304 are rotated to a position inside of the main body 306 of the grill 300. As such, there is a gap between the periphery of the top surface of the grates 356 and the periphery of the top edge of the cookbox 354 so that the doors 302, 304 can rotate down into the main body 306 by passing through the gap. The gap is sized and shaped to accommodate the front and rear doors 302, 304 when the front and rear doors 302, 304 rotate into the open position.

Both doors 302, 304 open by rotating downward relative to the main body 306 of the grill 300. In the closed position, the doors 302, 304 are in contact with each other at the top of the grill 300. In the open position, the doors 302, 304 are positioned internal to the main body 306 of the grill 300. One advantage of the grill 300 having two doors 302, 304 is that the heat from the grill 300 radiates upward when the grill doors 302, 304 are opened. Heat from the grill 300 radiating toward the user is avoided. Conversely, a conventional grill has a single door and when the door is manually opened, heat from the grill radiates towards the user, potentially causing pain and discomfort to the user.

The doors 302, 304 of the grill 300 open and close in response to input from a user. The input may be a press of a button. The button may be on the grill 300 or may be on a wireless remote control or key fob. In another example, the user input may be through an app on a mobile device. In yet another example, the user input may be through a motion sensor.

The grill 300 has an opening and closing mechanism similar to that of the grill 100 previously discussed herein. In particular, the opening and closing mechanism of the barbecue grill 300 includes an elevating mechanism that moves up and down towards and away from the doors 302, 304. The opening and closing mechanism of the barbecue grill 300 will be discussed in further detail with reference to FIGS. 3C and 3D. The doors 302, 304 of the grill 300 are coupled to a motor 322 through a series of cables, pulleys, and/or arms. The motor 322 is activated through input from the user to cause the doors 302, 304 to open or close. Notably, a single motor 322 is used to open and close the doors 302, 304. In this manner, the doors 302, 304 move simultaneously during the opening and closing processes. The mechanism for opening and closing the doors 302, 304 is a closed loop system that includes the motor 322, cables 324, pulleys 326, and arms 336, 338. However, it will be readily understood that the grill 300 is not limited to one motor and that two or more motors may be used to open and close the doors 302, 304. The single motor 322 causes the doors 302, 304 to open and close simultaneously.

When the doors 302, 304 reach the open configuration, the motor 322 automatically switches off. For example, when the doors 302, 304 reach a threshold open configuration, a different voltage reading is sent to the relay, which causes the motor 322 to switch off. Similarly, when the doors 302, 304 move from the open configuration to the closed configuration, the doors 302, 304 engage a stop, which causes the motor 322 to switch off. Since the opening and closing mechanism is a closed loop system, the doors 302, 304 move at the same speed at the same time and arrive in the same open or closed position every time the mechanism is operated.

The opening and closing mechanism depicted in FIGS. 3C and 3D includes a series of cables 324, a plurality of pulleys 326, blocks 328 that ride on tracks 330, front door arms 336, and rear door arms 338. The motor 322 is coupled to a power source 340. The motor 322 is also operatively coupled to the cables 324. Input from the user causes the motor 322 to activate in a first or second direction. If the doors 302, 304 are closed, the user input causes the motor 322 to activate in a first direction to open the doors 302, 304. If the doors 302, 304 are open, the user input causes the motor 322 to activate in a second direction opposite of the first direction in order to close the doors 302, 304. Activation of the motor 322 in the first direction causes the cables 324 to move in a first direction, as indicated by the arrows 342 shown in FIG. 3C. Conversely, activation of the motor 322 in the second direction causes the cables 324 to move in a second direction, as indicated by the arrows 344 shown in FIG. 3D. The cables 324 are wrapped around the pulleys 326 and movement of the cables 324 causes the pulleys 326 to rotate in conjunction with the movement of the cables 324. The pulleys 326 are fixed pulleys. That is, the pulleys 326 rotate, but are fixed in place.

The blocks 328 are fixedly coupled to the cables 324 so that movement of the cables 324 in a first direction causes the blocks 328 to move downwards away from the doors 302, 304, and movement of the cables 324 in a second direction causes the blocks 328 to move upwards towards the doors 302, 304. The blocks 328 ride on tracks 330. The tracks 330 hold the blocks 328 in position along their intended pathway. The front door arms 336 and rear door arms 338 are rotatably coupled to the blocks 328 so that, as the blocks 328 move downwards, the front door arms 336 and rear door arms 338 pull on the front door 302 and rear door 304, respectively, and hinge away from each other. As the blocks 328 move upwards towards the doors 302, 304, the front door arms 336 and rear door arms 338 push outward on the front door 302 and read door 304, respectively, causing the front door 302 and rear door 304 to rotate upwards and inwards towards each other.

The doors 302, 304 rotate relative to each other around rotation axis 305. The front door arms 336 and rear door arms 338 rotate relative to each other around rotation axis 337. The front door arms 336 and the front door 302 rotate relative to each other around rotation axis 332. The rear door arms 338 and the rear doors 304 rotate relative to each other around rotation axis 334.

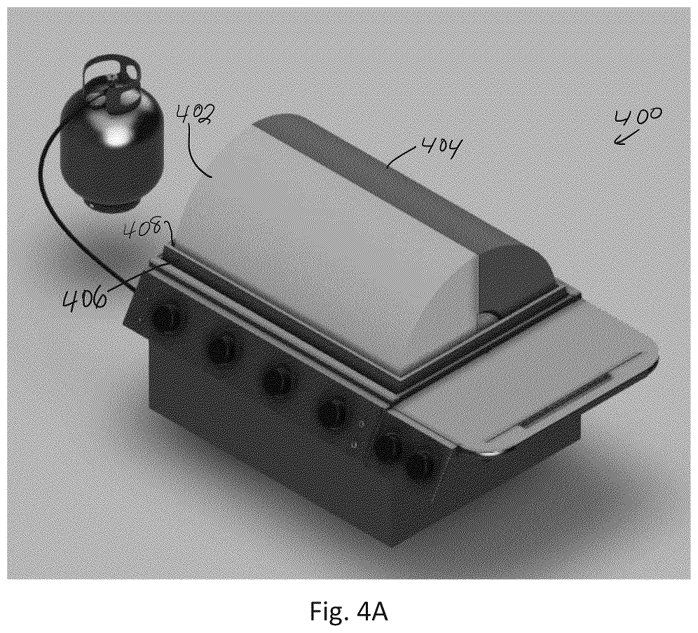

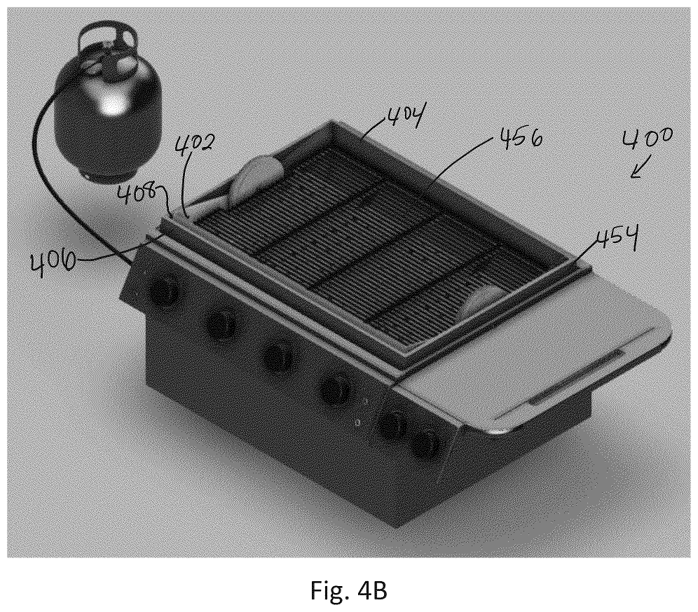

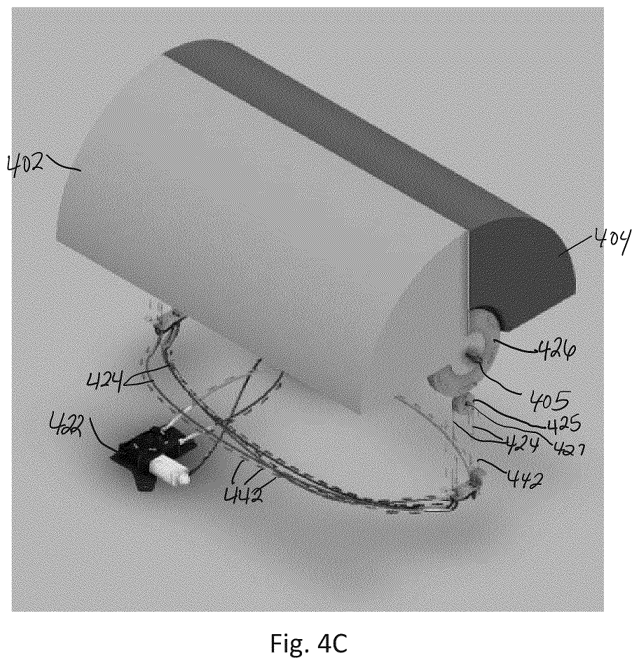

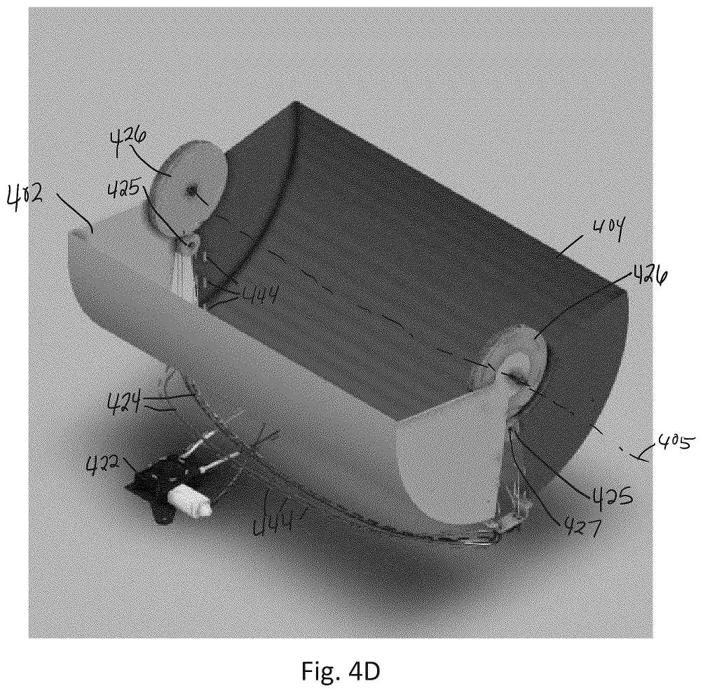

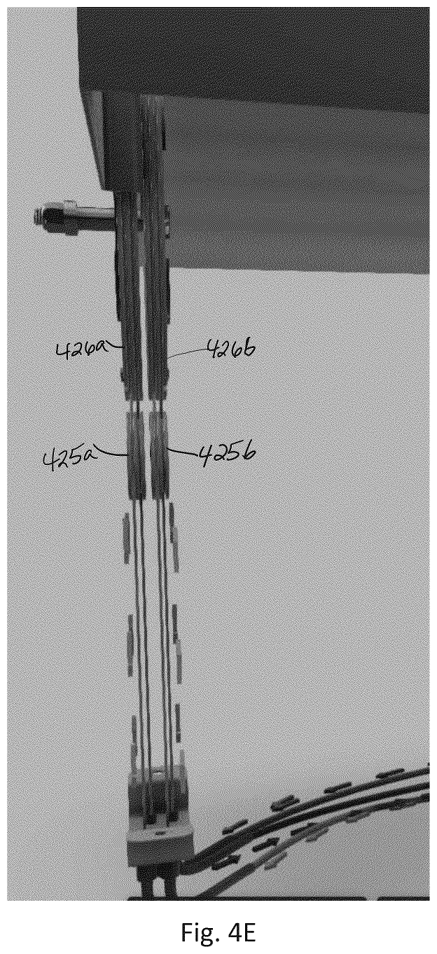

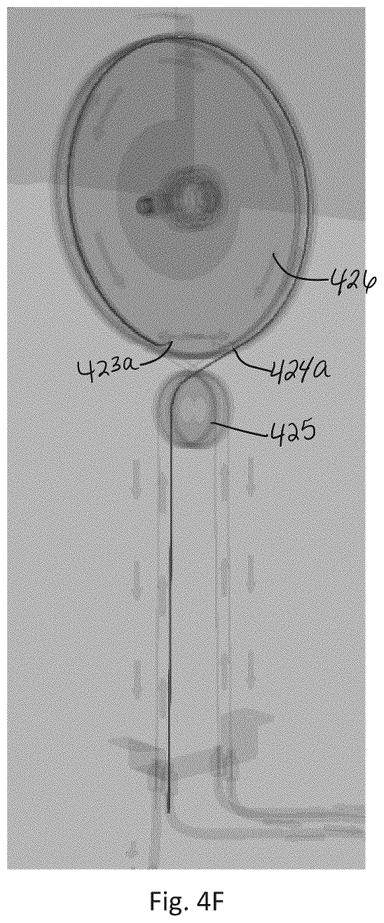

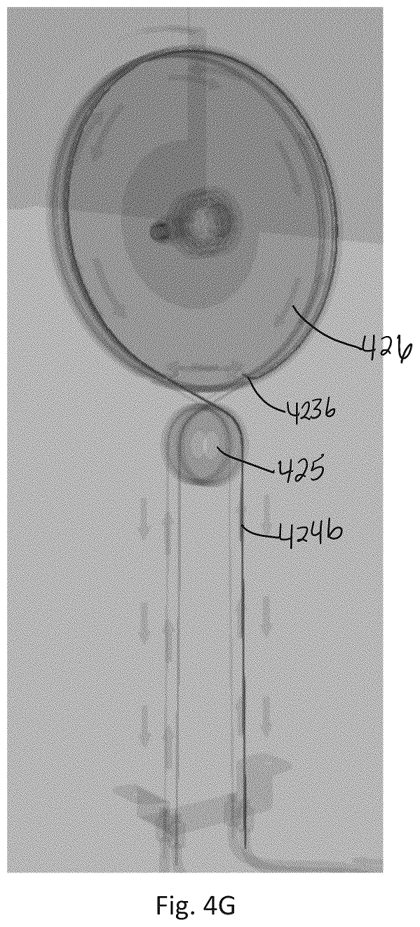

FIGS. 4A-4D illustrate another example of a barbecue grill 400 having doors 402, 404 that open and close automatically in response to input from a user. The doors 402, 404 are similar to the doors 302, 304 of the grill shown in FIGS. 3A-3D. The opening and closing mechanism of the grill 400 is similar to the opening and closing mechanism of the grill 200 shown in FIGS. 2A-2D. The barbecue grill 400 is smaller than the grills 100, 300, so the opening and closing mechanism has to be smaller to accommodate the compact size of the grill 400. The compact size 400 makes the grill 400 advantageous for tailgating, using on boats or RV's, or adding to a built-in patio barbecue area.

The first door 402, also referred to as the front door 402, opens by rotating downward relative to the body 406 of the grill 400. Similarly, the second door 404, also referred to as the rear door 404, rotates downward relative to the body 406 of the grill 400. The doors 402, 404 are the same size and shape as each other. The doors 402, 404 rotate about a fixed rotation axis 405. FIG. 4A depicts the barbecue grill 400 with the doors 402, 404 in a closed position and FIG. 4B depicts the barbecue grill 400 with the doors 402, 404 in an open position. As shown in FIG. 4B, when the barbecue grill 400 is in the open position, both doors 402, 404 are rotated to a position inside of the main body 406 of the grill 400. As such, there is a gap 408 between the periphery of the top surface of the grates 456 and the periphery of the top edge of the cookbox 454 so that the doors 402, 404 can rotate down into the grill body 406 by passing through the gap 408. The gap 408 is sized and shaped to accommodate the front and rear doors when the front and rear doors 402, 404 rotate into the open position.

The doors 402, 404 are the same shape and size as each other. Both doors 402, 404 open by rotating downward relative to the body 406 of the grill 400. In the closed position, the doors 402, 404 are in contact with each other at the top of the grill 400. In the open position, the doors 402, 404 are positioned internal to the main body 406 of the grill 400. One advantage of the grill 400 having two doors 402, 404 is that the heat from the grill 400 radiates upward when the grill doors 402, 404 are opened. Heat from the grill 400 radiating toward the user is avoided. Conversely, a conventional grill has a single door and when the door is manually opened, heat from the grill radiates towards the user, potentially causing pain and discomfort to the user.

The doors 402, 404 of the grill 400 open and close in response to input from a user. The input may be a press of a button. The button may be on the grill 400 or may be on a wireless remote control or key fob. In another example, the user input may be through an app on a mobile device. In yet another example, the user input may be through a motion sensor.

The grill 400 has an opening and closing mechanism similar to that of the grill 200 previously discussed herein. The opening and closing mechanism of the barbecue grill 400 will be discussed in further detail with reference to FIGS. 4C and 4D. The doors 402, 404 of the grill 400 are coupled to a motor 422 through a series of cables and pulleys. The motor 422 is activated through input from the user to cause the doors 402, 404 to open or close. Notably, a single motor 422 is used to open and close the doors 402, 404. In this manner, the doors 402, 404 move simultaneously during the opening and closing processes. The mechanism for opening and closing the doors 402, 404 is a closed loop system that includes the motor 422, cables 424, and pulleys 425, 426. However, it will be readily understood that the grill 400 is not limited to one motor and that two or more motors may be used to open and close the doors 402, 404. The single motor 422 causes the doors 402, 404 to open and close simultaneously.

When the doors 402, 404 reach the open configuration, the motor 422 automatically switches off. For example, when the doors 402, 404 reach a threshold open configuration, a different voltage reading is sent to the relay, which causes the motor 422 to switch off. Similarly, when the doors 402, 404 move from the open configuration to the closed configuration, the doors 402, 404 engage a stop, which causes the motor 422 to switch off. Since the opening and closing mechanism is a closed loop system, the doors 402, 404 move at the same speed at the same time and arrive in the same open or closed position every time the mechanism is operated.

The opening and closing mechanism depicted in FIGS. 4C and 4D includes a series of cables 424 and a plurality of pulleys 425, 426. The motor 422 is coupled to a power source. The motor 422 is also operatively coupled to the cables 424. Input from the user causes the motor 422 to activate in a first or second direction. If the doors 402, 404 are closed, the user input causes the motor 422 to activate in a first direction to open the doors 402, 404. If the doors 402, 404 are open, the user input causes the motor 422 to activate in a second direction opposite of the first direction in order to close the doors 402, 404. Activation of the motor 422 in the first direction causes the cables 424 to move in a first direction as indicated by the arrows 442 shown in FIG. 4C. Conversely, activation of the motor 422 in the second direction causes the cables 424 to move in a second direction, as indicated by the arrows 444 shown in FIG. 4D. The cables 424 wind around the pulleys 425, 426 and movement of the cables 424 causes the pulleys 425, 426 to rotate in conjunction with the movement of the cables 424. The pulleys 425, 426 are fixed pulleys. That is, the wheels of the pulleys 425, 426 rotate around a fixed rotation axis 405, 427.

Each one of the doors 402, 404 is fixedly coupled to a large pulley 426 on both sides of the door 402, 404. FIG. 4E depicts the pulley sets on one side of the grill 400. Each pulley set includes a small pulley 425 and a large pulley 426. Thus, FIG. 4E depicts a pulley set that includes a small pulley 425a and a large pulley 426a and another pulley set that includes a small pulley 425b and a large pulley 426b. The front door 402 is fixedly coupled to the first large pulley 426a and the rear door 404 is fixedly coupled to the second large pulley 426b. As such, the front door 402 and rear door 404 rotate when the respective large pulleys 426a, 426b rotate.

As shown in FIGS. 4F and 4G, there are two cables coupled to each set of pulleys. A first cable 424a has a first end 423a that is fixed to the large pulley 426. The first cable 424a winds almost completely around the large pulley 426 and around one side of the small pulley 425. FIG. 4G depicts a second cable 424b that has a second end 423b that is fixed to the large pulley 426. The second cable 424b winds almost completely around the large pulley 426 in a direction opposite that of the first cable 424a. The second cable 424b winds around the other side of the small pulley 425. As such, pulling on one cable 424a, 424b causes the large pulley 426 to rotate in one direction and pulling on the other cable 424a, 424b causes the large pulley 426 to rotate in the opposite direction.

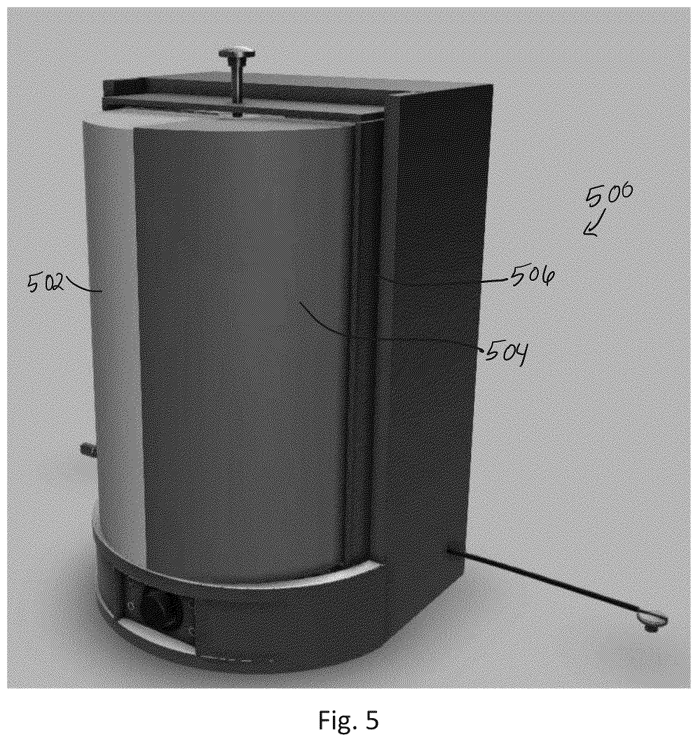

FIG. 5 depicts a vertical cooker 500 having automatic opening and closing doors 502, 504. The vertical cooker 500 is similar to the grill 400 depicted in FIGS. 4A-4G, except that the cooker 500 has a vertical arrangement instead of a horizontal arrangement. The doors 502, 504 open simultaneously in response to input from a user. The cooking area inside the body 506 of the cooker includes a vertical rotisserie spit (not shown) and a vertically-oriented heat source. The doors 502, 504 are substantially similar to the doors 402, 404 of the grill 400. The opening and closing mechanism for the doors 502, 504 includes cables and pulleys, similar to the opening and closing mechanism of the grill 400 in FIGS. 4A-4G.

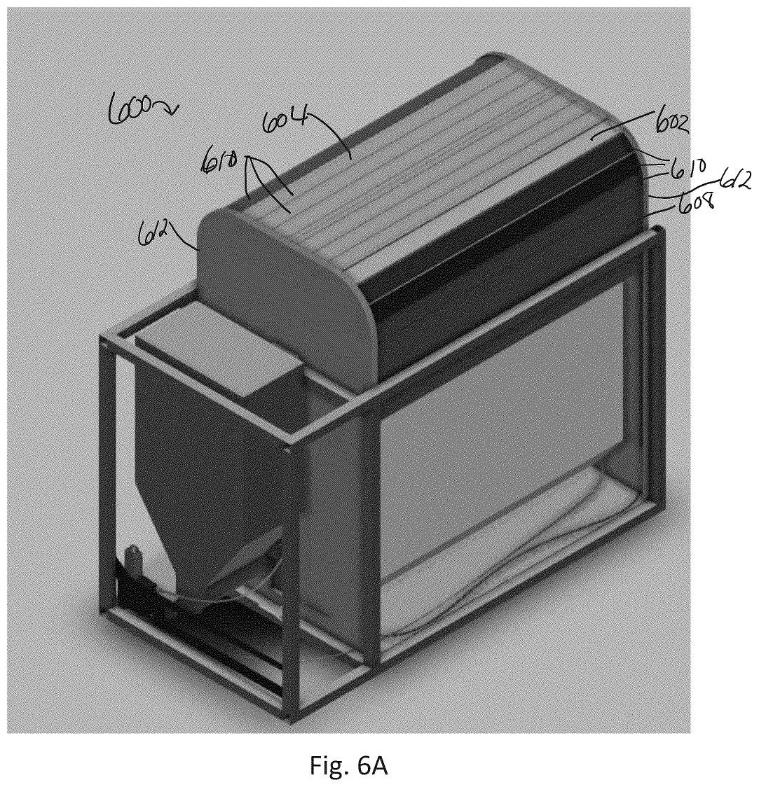

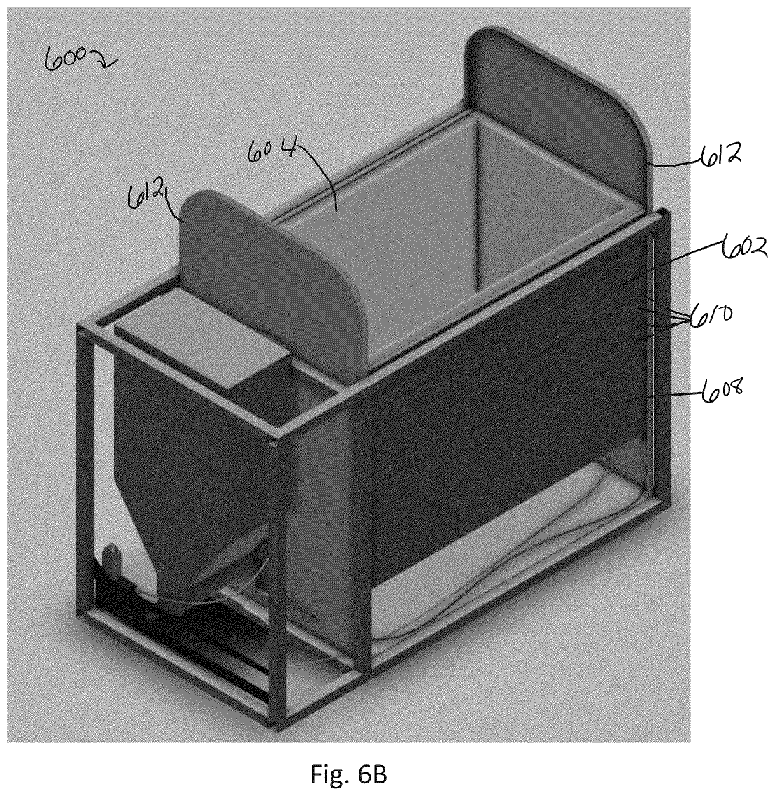

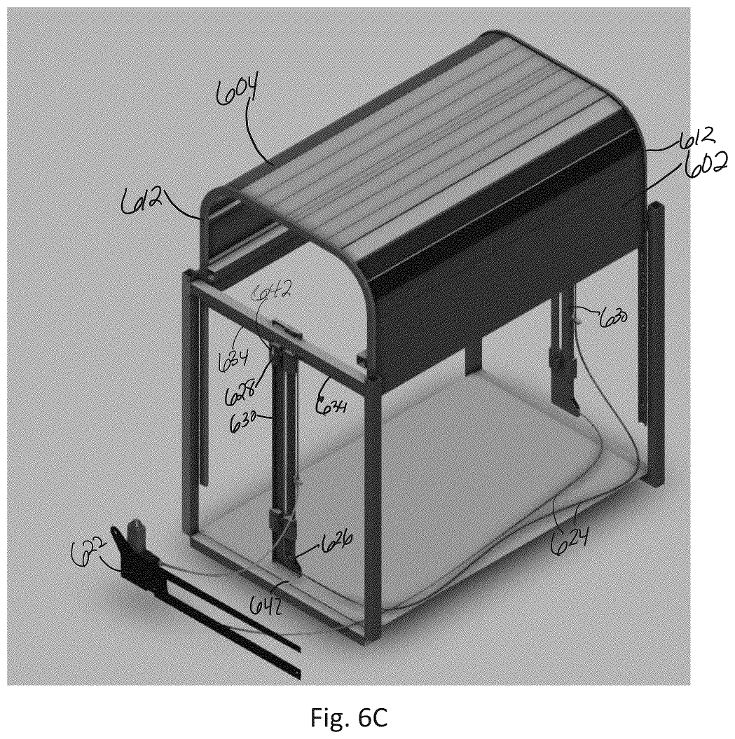

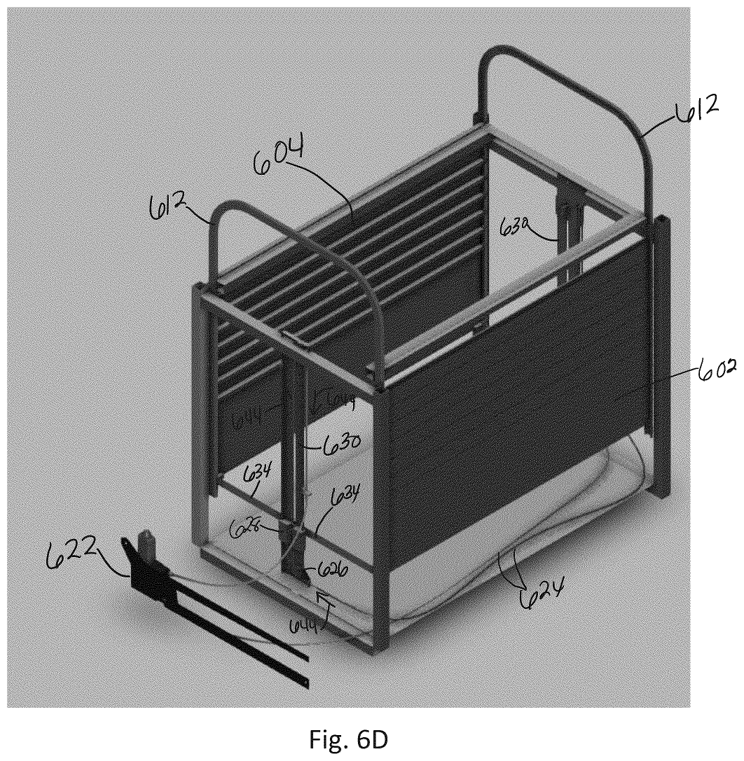

In another example, shown in FIGS. 6A-6D, a cooker 600 includes a first door 602 and a second door 604 that open and close automatically. The doors 602, 604 are similar in construction to a roll top desk. The doors 602, 604 include a plurality of panels that are hingedly connected to each other. One of the panels 608 is wider than the other panels 610 since the wider panel 608 remains in a vertical configuration. The cooker 600 includes guide rails 612 on either side of the doors 602, 604 and the door panels 608, 610 ride on the guide rails 612. As shown in FIG. 6B, when the cooker 600 is in the open position, the doors 602, 604 are completely vertical.

The doors 602, 604 of the cooker 600 open and close in response to input from a user. The input may be a press of a button. The button may be on the cooker 600 or may be on a wireless remote control or key fob. In another example, the user input may be through an app on a mobile device. In yet another example, the user input may be through a motion sensor.

The opening and closing mechanism of the cooker 600 will be discussed in further detail with reference to FIGS. 6C and 6D. The opening and closing mechanism of the cooker 600 include an elevating mechanism similar to that of the grill 100 in FIGS. 1A-1F. The doors 602, 604 of the cooker 600 are coupled to a motor 622 through a series of cables, pulleys, and arms. The motor 622 is activated through input from the user to cause the doors 602, 604 to open or close. Notably, a single motor 622 is used to open and close the doors 602, 604. In this manner, the doors 602, 604 move simultaneously during the opening and closing processes. The mechanism for opening and closing the doors 602, 604 is a closed loop system that includes the motor 622, cables 624, pulleys 626, and arms 634. However, it will be readily understood that the cooker 600 is not limited to one motor and that two or more motors may be used to open and close the doors 602, 604. The single motor 622 causes the doors 602, 604 to open and close simultaneously.

When the doors 602, 604 reach the open configuration, the motor 622 automatically switches off. For example, when the doors 602, 604 reach a threshold open configuration, a different voltage reading is sent to the relay, which causes the motor 622 to switch off. Similarly, when the doors 602, 604 move from the open configuration to the closed configuration, the doors 602, 604 engage a stop, which causes the motor 622 to switch off. Since the opening and closing mechanism is a closed loop system, the doors 602, 604 move at the same speed at the same time and arrive in the same open or closed position every time the mechanism is operated.

The opening and closing mechanism depicted in FIGS. 6C and 6D includes a series of cables 624, a plurality of pulleys 626, blocks 628 that ride on tracks 630, and arms 634 that are fixedly couple the blocks 628 and to the bottom corners of the doors 602, 604. The motor 622 is coupled to a power source. The motor 622 is also operatively coupled to the cables 624. Input from the user causes the motor 622 to activate in a first or second direction. If the doors 602, 604 are closed, the user input causes the motor 622 to activate in a first direction to open the doors 602, 604. If the doors 602, 604 are open, the user input causes the motor 622 to activate in a second direction opposite of the first direction in order to close the doors 602, 604. Activation of the motor 622 in the first direction causes the cables 624 to move in a first direction, as indicated by the arrows 642 shown in FIG. 6C. Conversely, activation of the motor 622 in the second direction causes the cables 624 to move in a second direction, as indicated by the arrows 644 shown in FIG. 6D. The cables 624 are wrapped around the pulleys 626 and movement of the cables 624 causes the pulleys 626 to rotate in conjunction with the movement of the cables 624. The pulleys 626 are fixed pulleys. That is, the pulleys 626 rotate around a rotation axis that is fixed in place.

The blocks 628 are fixedly coupled to the cables 624 so that movement of the cables 624 in a first direction causes the block 628 to move downwards, and movement of the cables 624 in a second direction causes the blocks 628 to move upwards. The blocks 628 ride on tracks 630. The tracks 630 hold the blocks 628 in position along their intended pathway. The arms 634 are fixedly coupled to the blocks 628 and to the bottom corners of the doors 602, 604 so that, as the blocks 628 move downwards, the arms 634 pull the doors 602, 604 downwards. As the blocks 628 move upwards, the arms 634 push the doors 602, 604 upwards.

In each of the above-illustrated examples of barbecue grills having automatic doors, the motor is coupled to a power source in addition to the user input device. The power source may be an electrical outlet, disposable battery, rechargeable battery, or the like. Further, the barbecue grill includes a fail safe so that the doors can be opened and closed manually if necessary.

In each of the above-illustrated examples of barbecue grills having automatic doors, the heat source may be any kind of known heat source or combination thereof. For example, the heat source for the grill may be natural gas, propane, charcoal, wood, wood pellet, gas infrared, electric, and/or electric infrared.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. An apparatus for cooking food having automatic doors, wherein the apparatus comprises:
a main body having a cooking area therein, wherein the cooking area comprises a heat source adjacent to a food holding area;
a first door;
a second door;
a motor configured for moving the first door and the second door between an open configuration and a closed configuration upon receiving user input through an input device, wherein the cooking area is accessible to a user when the first door and the second door are in the open configuration; and
a plurality of connectors for coupling the first door and the second door to the motor.

2. The apparatus of claim 1, wherein the plurality of connectors comprises at least two pulleys and a series of cables that are operatively engaged with the pulleys and with the motor.

3. The apparatus of claim 2, wherein the plurality of connectors further comprises at least two arms that are rotatably coupled to at least one of the first door and the second door.

4. The apparatus of claim 3, wherein the plurality of connectors further comprises two first door arms that are rotatably coupled to the first door and two second door arms that are rotatably coupled to the second door.

5. The apparatus of claim 2, further comprising:
two tracks, wherein one track is positioned on each side of the apparatus; and
two blocks, each one of the blocks operatively engaged with a respective one of the tracks and configured to ride on the respective one of the tracks,
wherein each one of the blocks is fixedly coupled to a respective one of the cables in the series of cables.

6. The apparatus of claim 1, wherein the apparatus is a barbecue grill and the first door and the second door are in a horizontal configuration.

7. The apparatus of claim 1, wherein the apparatus is a vertical rotisserie cooker and the first door and the second door are in a vertical configuration.

8. The apparatus of claim 1, further comprising a cook box, a burner assembly, and a gap between the cook box and the burner assembly, wherein the gap is sized and shaped to allow the first door to travel through the gap during an opening or closing process.

9. The apparatus of claim 1, wherein the first door is positioned inside of the grill body when the first door and the second door are in the open configuration.

10. The apparatus of claim 9, wherein both the first door and the second door are positioned inside of the grill body when the first door and the second door are in the open configuration.

11. The apparatus of claim 9, wherein the second door hinges upward relative to the main body when the first door and the second door are in the open configuration.

12. The apparatus of claim 1, wherein the first door and the second door are the same size and shape as each other.

13. The apparatus of claim 3, wherein the plurality of connectors further comprises two first door arms that are fixedly coupled to the first door, two second door arms that are rotatably coupled to the second door, and an elevator arm that is rotatably coupled to the first door arm and the second door arm.
